(19) United States
(12) Patent Application Publication
(10) Pub. No.: US 2018/0170266 A1
(43) Pub. Date: Jun. 21, 2018

(54) FIBER REINFORCED-PULTRUDED RUNNING BOARD

(71) Applicant: FORD GLOBAL TECHNOLOGIES, LLC, Dearborn, MI (US)

(72) Inventors: Paul Kenneth Dellock, Northville, MI (US); Stuart C. Salter, White Lake, MI (US); Michael A. Musleh, Canton, MI (US); David Brian Glickman, Southfield, MI (US); Talat Karmo, Waterford, MI (US); Geoffrey John Cooper, Canton, MI (US)

(21) Appl. No.: 15/380,587

(22) Filed: Dec. 15, 2016

(51) Int. Cl. B60R 3/00; B29C 47/00; B29C 47/06; B29C 35/16; C23C 18/16

(52) U.S. Cl. CPC B60R 3/002; B29C 47/0023; B29C 47/065; B29C 47/067; B29K 2105/08; B29C 35/16; C23C 18/1641; B29C 2035/1616; B29C 47/0066

(57) ABSTRACT

A running board includes an integral hollow body having a step face and a first sidewall. The integral hollow body is made from a base polymer material with continuous reinforcing fibers running from a first end to a second, opposite end of the first sidewall while the step face is made from unfilled base polymer material. A production method is also disclosed.

### TECHNICAL FIELD

This document relates generally to the motor vehicle equipment field and, more particularly, to a fiber reinforced-pultruded running board made from lightweight polymer materials.

### BACKGROUND

Running boards are a commonly installed option on many motor vehicles. State of the art running boards are relatively large and heavy parts that often weigh 50 or more pounds per vehicle. This added weight reduces the fuel economy of a motor vehicle equipped with state of the art running boards.

This document relates to a new and improved fiber reinforced-pultruded running board made from a low density polymer material that is selectively reinforced with continuous reinforcing fibers in the vertical sidewalls and reinforcing ribs. This adds strength and stiffness while limiting production costs. Advantageously, the new and improved running board may also include a premium finish for enhanced aesthetic appeal and customer satisfaction.

### SUMMARY

In accordance with the purposes and benefits described herein, a running board is provided. That running board comprises an integral hollow body including a step face and a first sidewall. The integral hollow body is made from a base polymer material and includes continuous reinforcing fibers running from a first end to a second end of the first sidewall.

The integral hollow body of the running board may further include a second sidewall having continuous reinforcing fibers running from a third end to a fourth end of the second sidewall. In addition, the integral hollow body may further include a reinforcing rib having continuous reinforcing fibers running from a fifth end to a sixth end of the reinforcing rib.

The integral hollow body of the running board may further include a bottom wall. Further, the first sidewall, the second sidewall and the reinforcing rib may extend between the step face and the bottom wall.

The base polymer material may be a thermoplastic polymer. That thermoplastic polymer may be selected from a group of materials consisting of acrylonitrile-butadiene-styrene, polycarbonate/acrylonitrile-butadiene-styrene, polyamide, nylon, polypropylene and combinations thereof.

The continuous reinforcing fibers may be selected from a group of fibers consisting of basalt fiber roving, carbon fiber roving and combinations thereof.

The step face may be made from unfilled base polymer material. For purposes of this document, unfilled base polymer material is defined as comprising a polymer material void of reinforcing fibers. The bottom wall may also be made from unfilled base polymer material.

The running board may also include an outer layer of platable polymer material. An optional tie-layer may be provided between the base polymer material and the outer layer of platable polymer material in those situations where the outer layer of platable polymer material will not bind to the base polymer material with the necessary strength to prevent delamination.

The running board may also include a plurality of mounting points in at least one of the step face and the bottom wall. A running board accessory may be secured to the plurality of mounting points. That running board accessory may be selected from an accessory group consisting of a mounting bracket, a step pad, a tread, an end cap and combinations thereof.

In accordance with an additional aspect, a method is provided of manufacturing a running board. That method comprises the steps of: (a) extruding a hollow body from a base polymer, (b) selectively positioning continuous reinforcing fibers in the base polymer material of a first sidewall of the hollow body so as to run from a first end to a second end of the first sidewall and (c) extruding an outer layer of platable polymer material over the base polymer material.

The method may also include the step of extruding a tie-layer over the base polymer material before extruding the outer layer of the platable polymer material. In addition, the method may include the step of cooling the running board in water following extruding. Further, the method may include the step of cutting the running board to length following cooling.

In accordance with an additional aspect, a method of manufacturing a running board comprises extruding a hollow body from a base polymer material wherein the hollow body includes (a) a step face, (b) a bottom wall and (c) a first sidewall, a second sidewall and at least one reinforcing rib extending between the step face and the bottom wall. In addition, the method includes selectively positioning continuous reinforcing fibers in (1) the first sidewall extending from a first end to a second end thereof, (2) the second sidewall extending from a third end to a fourth end thereof and (3) the reinforcing rib extending from a fifth end to a sixth end thereof.

Still further, the method includes extruding an outer layer of platable polymer material over the base polymer material. Further, the method includes the steps of cooling the running board, cutting the running board to length and plating the running board.

In some embodiments, the method includes extruding a tie-layer over the base polymer material before extruding the outer layer of the platable polymer material.

In the following description, there are shown and described several preferred embodiments of the running board as well as the method of manufacturing the running board. As it should be realized, the running board and manufacturing method are capable of other, different embodiments and their several details are capable of modification in various, obvious aspects all without departing from the running board and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the running board and method and together with the description serve to explain certain principles thereof. In the drawing figures:

FIG. 1 is a cross-sectional view of a first possible embodiment of the running board.

FIG. 2 is a cross-sectional view of a second possible embodiment of the running board.

FIG. 3 is a perspective view of two running boards incorporating accessories in the form of mounting brackets, step pads, treads and end caps.

FIG. 4 is a schematic block diagram illustrating one possible embodiment of the method of manufacturing a fiber reinforced-pultruded running board.

Reference will now be made in detail to the present preferred embodiments of the running board and manufacturing method, examples of which are illustrated in the accompanying drawing figures.

### DETAILED DESCRIPTION

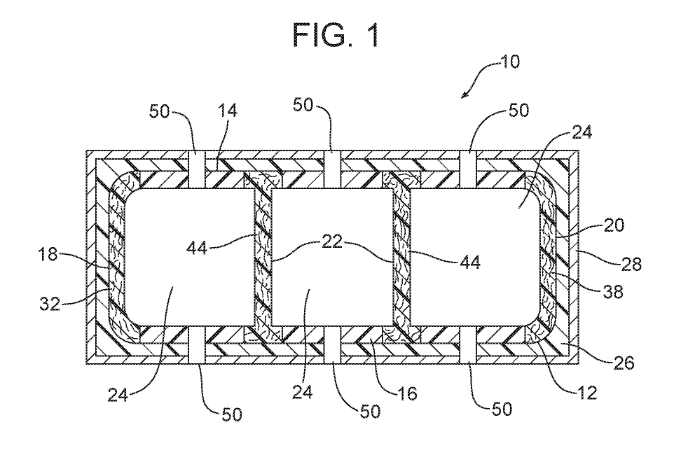

Reference is now made to FIG. 1 illustrating a first embodiment of the running board 10. The running board 10 illustrated in FIG. 1 includes an integral hollow body 12 including a step face 14, a bottom wall 16, a first sidewall 18, a second sidewall 20 and two spaced reinforcing ribs 22. In the illustrated embodiment, the first sidewall 18, the second sidewall 20 and the two reinforcing ribs 22 extend between the step face 14 and the bottom wall 16 and define three hollow cells 24.

The FIG. 1 embodiment of the running board 10 further includes an outer layer of platable polymer material 26 and a plating layer 28 covering the outer layer of platable polymer material.

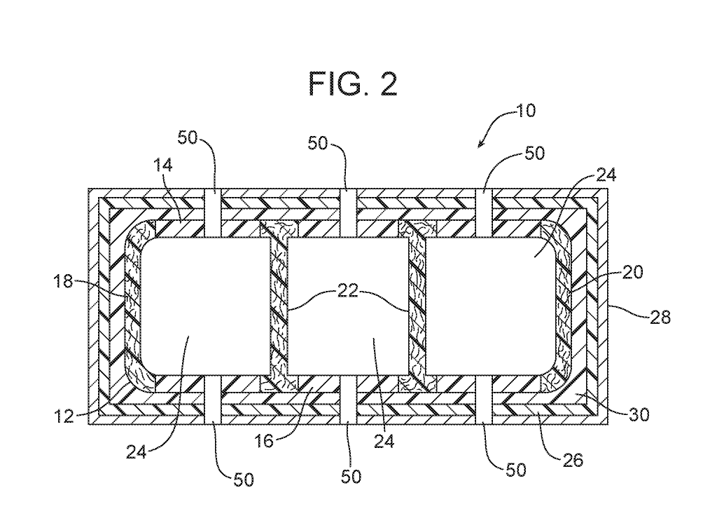

The second embodiment of the running board 10 illustrated in FIG. 2 is identical to the first embodiment illustrated in FIG. 1 except for the provision of a tie-layer 30 between the outer layer of platable polymer material 26 and the integral hollow body 12.

In either of the embodiments of the running board 10 illustrated in FIGS. 1 and 2, the integral hollow body 12 is made from a base polymer material. That base polymer material may comprise a thermoplastic polymer. That thermoplastic polymer may be selected from a group of materials consisting of acrylonitrile-butadiene-styrene, polycarbonate/acrylonitrile-butadiene-styrene, polyamide, nylon, polypropylene and combinations thereof.

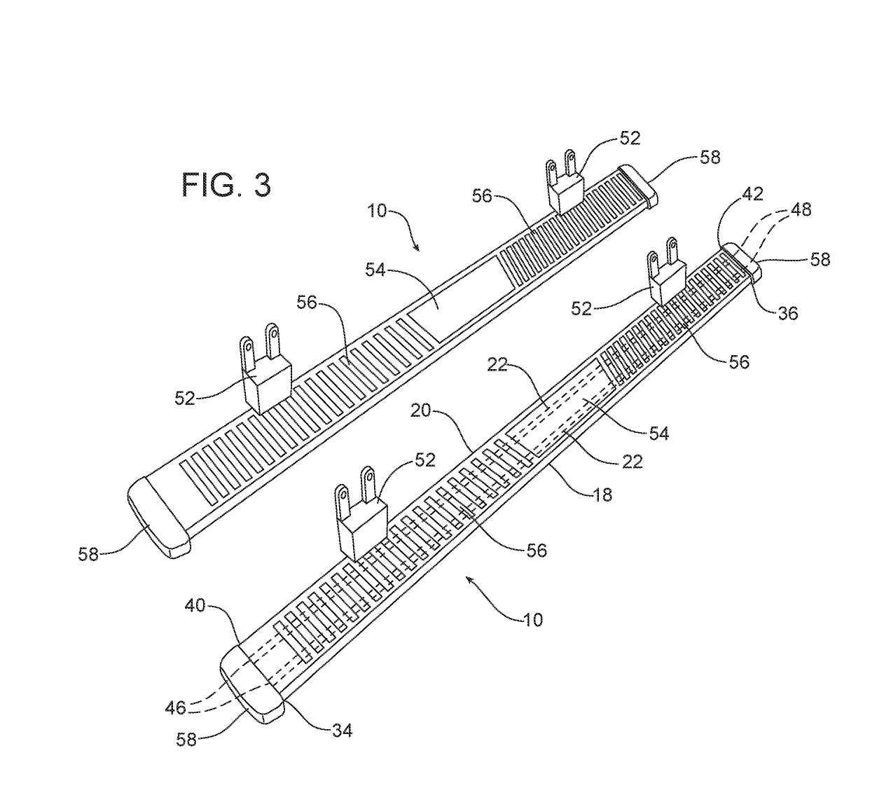

More specifically describing the running boards 10 illustrated in FIGS. 1 and 2, the step face 14 and bottom wall 16 between the first sidewall 18, second sidewall 20 and reinforcing ribs 22 may be made from an unfilled base polymer material. In contrast, the first sidewall 18 may be made from the base polymer material and continuous reinforcing fibers 32 extending along a longitudinal axis of the first sidewall 18 from a first end 34 to a second end 36 as illustrated in FIG. 3.

Similarly, the second sidewall 20 may be made from the base polymer material and continuous reinforcing fibers 38 extending from a third end 40 to a fourth end 42 of the second sidewall. Further, each of the reinforcing ribs 22 is made from the base polymer material and continuous reinforcing fibers 44 extending the longitudinal length of the reinforcing ribs from a fifth end 46 to a sixth end 48 of those ribs.

The continuous reinforcing fibers 32, 38 and 44 may be selected from a group of fibers consisting of basalt fiber roving, carbon fiber roving and combinations thereof.

In one possible embodiment, the first sidewall 18, the second sidewall 20, and the reinforcing ribs 22 are made from carbon fiber 25%-35% reinforced acrylonitrile-butadiene-styrene. The step face 14 and the bottom face 16 are made from unfilled acrylonitrile-butadiene-styrene.

In another possible embodiment, the step face 14 and the bottom wall 16 are again made from unfilled acrylonitrile-butadiene-styrene but the first sidewall 18, the second sidewall 20 and the reinforcing ribs 22 are made from basalt 45% to 65% reinforced acrylonitrile-butadiene-styrene.

As further illustrated in FIGS. 1-3, a plurality of mounting points 50, in the form of apertures, are provided in the step face 14 and the bottom wall 16: that is, the unfilled base polymer material. A running board accessory may be secured to any one or more of the plurality of mounting points 50. As illustrated in FIG. 3, the running board accessory may comprise a running board mounting bracket 52, a step pad 54, a tread 56 or an end cap 58.

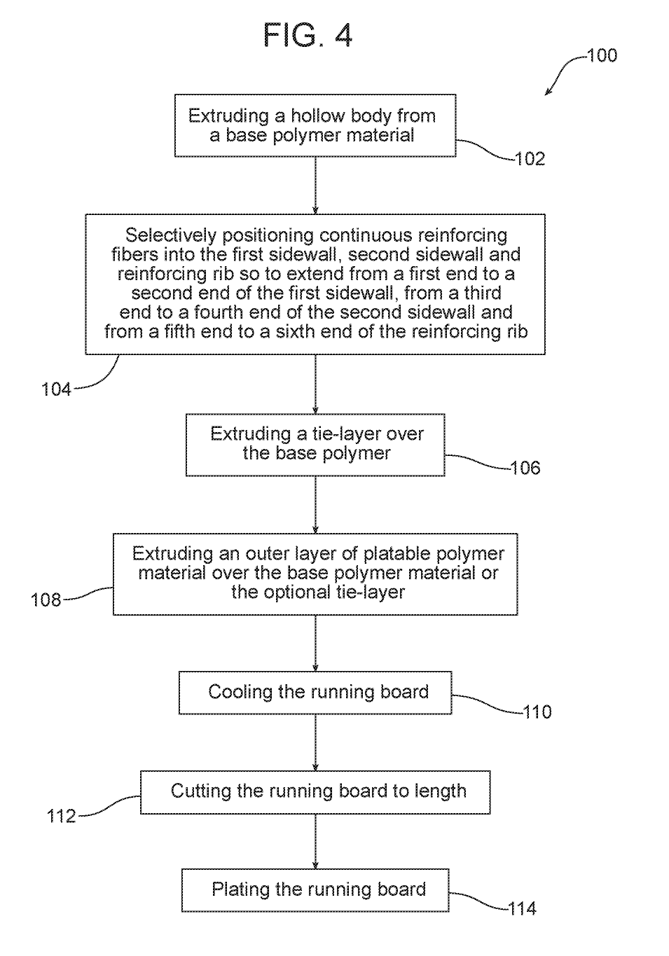

Reference is now made to FIG. 4 which is a schematic block diagram of a method of manufacturing the running board 10. As illustrated in FIG. 4, the method 100 includes a step of extruding the integral hollow body 12 from a base polymer material (see box 102). Further, the method also includes the step of selectively positioning continuous reinforcing fibers 32, 38 and 44 into the respective first sidewall 18, second sidewall 20 and reinforcing ribs 22. More specifically, this is done so the continuous reinforcing fibers 32 in the first sidewall 18, extend uninterrupted from a first end 34 to a second end 36 thereof. The reinforcing fibers 38 in the second sidewall 20 extend uninterrupted from a third end 40 to a fourth end 42 thereof. The continuous reinforcing fibers 44 in the reinforcing ribs 22 extend uninterrupted from a fifth end 46 to a sixth end 48 thereof. (Note box 104) Further, the method may include the optional step of extruding a tie-layer over the base polymer material of the integral hollow body 12 (see box 106).

As further illustrated in FIG. 4, the method 100 also includes the step of extruding an outer layer of platable polymer material 26 over the base polymer material of the integral hollow body 12 or the optional tie-layer 30. See box 108. Here it should be appreciated that the optional tie-layer 30 is only extruded and provided when required to ensure proper bonding of the outer layer of platable polymer material 26 to the base polymer material of the integral body 12.

As further illustrated in FIG. 4, the method 100 also includes the step of cooling the running board 10 following the extruding steps. (Note box 110) This cooling may be done by contacting the running board with water following extruding.

Further, the method 100 includes the step of cutting the running board to a desired length (note box 112). In addition, where a plated premium finish is desired, the method may include the step of plating the running board (note box 114) by means of plating operations or procedures that are known in the art.

In summary, the fiber reinforced-pultruded running board 10 is characterized by a number of benefits and advantages. The running board 10 is made from low cost, low density polymer materials that provide about a 40% weight save with respect to aluminum when utilizing basalt fiber rovings and a 55% weight save versus aluminum when using carbon fiber rovings.

While aluminum running boards require extensive and time consuming polishing to achieve desirable chrome, painted or other premium finishes, the pultruded running board 10 can be quickly and easily painted or chrome plated with a premium finish at a substantially reduced cost of perhaps $5.00 to $7.00 per running board. Advantageously, it should also be appreciated that multiple appearances and finishes may be provided to the outer layer of platable polymer material 26 on a single set of tools thereby reducing capital investment and offering design flexibility.

The foregoing has been presented for purposes of illustration and description. It is not intended to be exhaustive or to limit the embodiments to the precise form disclosed. Obvious modifications and variations are possible in light of the above teachings. Obvious modifications and variations are possible in light of the above teachings. For example, the running board 10 need not include an outer plating layer 28 if another, different finish is desired. All such modifications and variations are within the scope of the appended claims when interpreted in accordance with the breadth to which they are fairly, legally and equitably entitled.

What is claimed:

1. A running board, comprising:
an integral hollow body including a step face and a first sidewall wherein said integral hollow body is made from a base polymer material and includes continuous reinforcing fibers running from a first end to a second end of said first sidewall.

2. The running board of claim 1, wherein said integral hollow body further includes a second sidewall including said continuous reinforcing fibers running from a third end to a fourth end of said second sidewall.

3. The running board of claim 2, wherein said integral hollow body further includes a reinforcing rib including said continuous reinforcing fibers running from a fifth end to a sixth end of said reinforcing rib.

4. The running board of claim 3, wherein said integral hollow body further includes a bottom wall and said first sidewall, said second sidewall and said reinforcing rib extend between said step face and said bottom wall.

5. The running board of claim 4, wherein said base polymer material is a thermoplastic polymer.

6. The running board of claim 5, wherein said thermoplastic polymer is selected from a group of materials consisting of acrylonitrile-butadiene-styrene, polycarbonate/acrylonitrile-butadiene-styrene, polyamide, nylon, polypropylene and combinations thereof.

7. The running board of claim 6, wherein said continuous reinforcing fibers are selected from a group of fibers consisting of basalt fiber roving, carbon fiber roving and combinations thereof.

8. The running board of claim 7, wherein said step face is made from unfilled base polymer material.

9. The running board of claim 8, wherein said bottom wall is made from unfilled base polymer material.

10. The running board of claim 9, further including an outer layer of platable polymer material.

11. The running board of claim 10, further including a tie-layer between said base polymer material and said outer layer of platable polymer material.

12. The running board of claim 11, further including a plurality of mounting points in at least one of said step face and said bottom wall.

13. The running board of claim 12, further including a running board accessory secured to said plurality of mounting points.

14. The running board of claim 13, wherein said running board accessory is selected from an accessory group consisting of a mounting bracket, a step pad, a tread, an end cap and combinations thereof.

15. A method of manufacturing a running board, comprising:
extruding a hollow body from a base polymer material;
selectively positioning continuous reinforcing fibers in said base polymer material of a first sidewall of said hollow body so as to run from a first end to a second end of said first sidewall; and
extruding an outer layer of platable polymer material over said base polymer material.

16. The method of claim 15, further including extruding a tie-layer over said base polymer material before extruding said outer layer of platable polymer material.

17. The method of claim 15, further including cooling said running board in water following extruding.

18. The method of claim 17, including cutting said running board to length following cooling.

19. A method of manufacturing a running board, comprising:
extruding a hollow body from a base polymer material wherein said hollow body includes (a) a step face, (b) a bottom wall and (c) a first sidewall, a second sidewall and at least one reinforcing rib extending between said step face and said bottom wall;
selectively positioning continuous reinforcing fibers in (1) said first sidewall extending from a first end to a second end thereof, (2) said second sidewall extending from a third end to a fourth end thereof and (3) said reinforcing rib extending from a fifth end to a sixth end thereof;
extruding an outer layer of platable polymer material over said base polymer material;
cooling said running board;
cutting said running board to length; and
plating said running board.

20. The method of claim 19, including extruding a tie-layer over said base polymer material before extruding said outer layer of said platable polymer material.
